(19) United States
(12) Patent Application Publication
(10) Pub. No.: US 2026/0043775 A1
(43) Pub. Date: Feb. 12, 2026

(54) METHODS, MEDIUMS, AND SYSTEMS FOR REVIEWING CHROMATOGRAMS BASED ON EXCEPTIONS

(71) Applicant: Waters Technologies Ireland Limited, Dublin (IE)

(72) Inventor: Todor Petrov, Mansfield, MA (US)

(21) Appl. No.: 19/294,067

(22) Filed: Aug. 7, 2025

Related U.S. Application Data
(60) Provisional application No. 63/680,360, filed on Aug. 7, 2024.

(51) Int. Cl. G01N 30/86

(52) U.S. Cl. CPC G01N 30/8693; G01N 30/8637; G01N 30/8675

(57) ABSTRACT

Exemplary embodiments provide methods, mediums, and systems for facilitating the review of chromatography data. An interface may be presented displaying multiple chromatograms or other types of chromatography data. The interface is configured to receive input that selects a subset of the displayed chromatography data, which is designated as known-good data. The remaining chromatography data is compared to the known-good data using machine learning or heuristics. Based on (e.g.) the peak shapes in the chromatograms, the system determines whether the remaining chromatograms are within an acceptable tolerance of the known-good data or represents a deviation. Using this technique, a user is empowered to train the system based on site-specific or user-specific known-good data, thus allowing the user to quickly determine which of the results may require further investigation.

### CROSS-REFERENCE TO RELATED APPLICATIONS

This application claims the benefit of and priority to U.S. Provisional Patent Application No. 63/680,360 , filed Aug. 7, 2024, the entire contents of which are hereby incorporated by reference.

### BACKGROUND

Laboratory analytical instruments are devices for qualitatively and/or quantitatively analyzing samples. They are often used in a laboratory setting as part of an analytical chemistry system for scientific research or testing. Such devices may measure the chemical makeup of a sample, determine the quantity of components in a sample, and perform similar analyses. Examples of laboratory analytical instruments include mass spectrometers, chromatographs, titrators, spectrometers, elemental analyzers, particle size analyzers, rheometers, thermal analyzers, etc.

Chromatography, which includes liquid chromatography (LC), high-performance liquid chromatography (HPLC), liquid chromatography-mass spectrometry (LC-MS), and gas chromatography (GC) is a crucial analytical technique widely used in many industries including the pharmaceutical industry. Liquid chromatography separates a sample that may include complex molecules into its individual components. The separation generally occurs as the sample interacts a mobile (liquid or gas) phase, such as a solvent, and a stationary (solid) phase that is usually packed into a column. Components with varying polarities migrate through the column at different speeds, based on their affinity for the mobile phase. If components have different polarities, one may migrate faster than the other. As they elute from the column, they form distinct bands. In some cases, colored components create visible bands. However, in techniques like HPLC, other detectors (e.g., UV-VIS spectroscopy) identify the bands.

A chromatogram is a graphical representation of the separation process in chromatography. It shows how different components of a sample move through the chromatographic system over time. The horizontal axis of a chromatogram typically represents retention time (or elution time). It indicates the time taken for each component to travel through the column and reach the detector. The vertical axis typically represents signal intensity. This could be absorbance, fluorescence, or other detector responses.

Peaks on the chromatogram correspond to different sample components. The area under the peak corresponds to the quantity of that component in the sample.

A chromatogram may include a baseline, which is a flat line at the bottom of the chromatogram. Peaks rise above this line. Good chromatography aims for well-separated peaks with minimal overlap.

Among many other applications, chromatograms play a crucial role in pharmaceutical quality control. For example, chromatography is essential for testing drug identity, purity, and potency. It ensures high-quality pharmaceutical products and patient safety. By analyzing chromatograms, scientists verify that the active ingredients meet specifications and detect any impurities.

During drug manufacturing one or more manufacturing lines may be run, each of which produces a pharmaceutical product or a component of a pharmaceutical product. At different points in the manufacturing process, samples may be collected from these manufacturing lines and subjected to chromatography. This results in multiple chromatograms produced at various points in the process. These chromatograms need to be reviewed to determine if the samples are as expected (with the expected molecules in the expected concentrations, and without unexpected impurities above certain allowable thresholds). Current regulations do not permit this review to be automated: a human scientist must generally review and approve (or reject) each chromatogram. An individual scientist will generally review numerous chromatograms during the quality control process. They may spend a significant amount of their day performing these reviews, and are likely to miss several anomalous chromatograms.

Note that, although some exemplary embodiments may be described in connection with pharmaceutical quality control, the present invention is not so limited. Other fields in which these embodiments may be applied include drug/pharmaceutical research and development and LC or GC column manufacturing and research and development.

### BRIEF SUMMARY

Exemplary embodiments relate to computer-implemented methods, as well as non-transitory computer-readable mediums storing instructions for performing the methods, computing apparatuses having a non-transitory medium storing instructions configured to perform the methods and a processor configured to execute the instructions, and other logical and hardware constructs that may perform the techniques described herein.

According to some embodiments, a computer-implemented method includes accessing a plurality of samples from a chromatographic analysis. In the chromatographic analysis, as each compound elutes it creates a signal that rises above the baseline noise, forming what is known as a peak. The peak's height or area correlates to the compound's concentration.

Thus, each sample may be represented as a structure (e.g., a data structure) that includes detection times and signal intensities corresponding to the detection times. For example, the detection time may be a retention time (a measurement of the amount of time taken for a solute to pass through a chromatography column). The signal intensity for a given detection time may be a measurement of the number of molecules that register on a detector at the detection time. Each structure may include an identifier for the sample (e.g., a name assigned to the sample, a timestamp, etc.).

In some embodiments, peak detection may be performed to identify one or more peaks in the data for the sample, where a peak represents an area around a local maximum of the signal intensities. Sophisticated algorithms within chromatography data systems (CDS) are employed to distinguish these peaks from random noise and to accurately define their start, apex, and end. This is achieved by setting thresholds for detection parameters, such as peak width, height, and area, which may be optimized to ensure reliable peak identification. The peak width is measured at the baseline and is used to determine a bunching factor, which helps in distinguishing the peak from the baseline. The threshold parameter specifies the minimum rate of change of the detector signal required to identify the start and end of a peak. Once a potential peak start is identified, the signal is monitored until a change from a positive to a negative slope is observed, indicating the peak apex. The end of the peak is determined when consecutive slopes fall below the touchdown threshold. Minimum height or area parameters are also set to reject unwanted peaks, ensuring only significant peaks are reported. In some cases, manual integration may be used when automated methods fail to accurately capture complex peak shapes or when peaks overlap significantly.

A summary of information for the analyzed samples may be displayed on a display of a computing device. The summary of information may be displayed in a sample information display interface. Among other information, at least an identifier for each of the samples may be displayed. A user may select a subset of known-good samples (i.e., the subset may be a number n of samples selected from among the s analyzed sample, where 1≤n<s) from among the analyzed samples. In some embodiments, good results can be achieved with as few as 3-5 known-good samples.

The remaining samples not in the selection of the subset of known-good samples may represent a subset of comparison samples. In some embodiments, only a selected subset of the comparison samples are selected for further processing.

The subset of known-good samples may be used to configure a model. The model may be, for example, a structure or representation that abstracts properties of the known-good samples, such as the number of peaks, shapes of the peaks, etc.

In some embodiments, the model maybe a supervised learning model. For instance, the model may be an aggregated or averaged chromatogram. The model may be a structure that includes detection times and a mean signal intensity among the known-good samples at each detection time.

For each of the comparison samples, the model may be applied to the comparison sample to determine a similarity score. The similarity score may be a quantified or qualified representation of how closely the comparison sample matches the data from the known-good samples. For example, the similarity score may be based on a comparison of one or more of a number or shape of peaks in each comparison sample as compared to the model.

For instance, when the model is a supervised learning model with a structure representing the mean signal intensities among the known-good samples, determining the similarity score may include, for each comparison sample, determining differences between signal intensities for the comparison sample and corresponding mean signal intensities at corresponding detection times from the model, and computing the similarity score based on the differences. A greater amount of difference may result in a lower similarity score.

This process may be visualized as comparing points in an N-dimensional space. For instance, when the model is a supervised learning model with a structure representing multiple chromatograms of N signal intensity readings, each as a point in an N-dimensional space where the coordinates are the signal intensity readings, determining the similarity score may include for each comparison sample, computing the distance between the N-dimensional point for the comparison sample and the center of the cloud representing the known-good samples, and computing the similarity score based on that distance. A greater distance may result in a lower similarity score.

The supervised learning model may also be a supervised machine learning model. In some examples, the supervised learning model may be a neural network or other machine learning construct. The supervised learning model may be trained, using the subset of known-good samples as training data. The supervised learning model may take one of the comparison samples as an input and may generate, as an output, the comparison score.

The similarity score may be displayed on the display. For example, the similarity score may be displayed near the sample identifier on the sample information display interface. In some embodiments, the different comparison sample identifiers and/or scores may be visually distinguished based on each comparison sample's similarity score. For instance, a predefined threshold are considered to be sufficiently similar to the known-good samples and scores below the threshold are considered to be anomalous. The low scores may be highlighted in red, whereas the high scores may be highlighted in green. Alternatively, other techniques for visually distinguishing the scores may be used, such as varying the size, typeface, font color, background color, font type, etc.

One of the comparison samples may be selected in the interface, and a chromatogram representation of the known-good samples and a chromatogram representation of the selected one of the comparison samples may be displayed for comparison. In some embodiments, peaks in the chromatogram for the known-good sample may be labeled (e.g., with a molecule name corresponding to the peak). Peaks in the chromatogram for the comparison sample that correspond to the peaks in the known-good sample may also be labeled with the corresponding molecule name. Peaks in the comparison sample without an equivalent in the known-good sample may be unlabeled and/or may be visually distinguished in other ways (e.g., by highlighting, circling, bolding, etc. the unmatched peak).

In some embodiments, a pattern in the chromatogram of the selected comparison sample may be identified. For example, the pattern may be an unmatched peak that corresponds to an impurity, or a malformed peak that may have been caused by a miscalibration of the chromatograph or other device in an analytical chemistry system. A processor may conduct a search through historical sample data to identify previous samples having the identified pattern, in order to trace the source of the impurity or miscalibration.

Applying the model may have a number of technical advantages. It may reduce the number of comparison samples that need to be individually verified (e.g., by allowing a user to skip or only briefly review the chromatograms with high similarity scores and/or by flagging the chromatograms with low similarity scores). Consequently, throughput of chromatogram review in a quality control process is increased. It may reduce the number of analysts needed to manually review chromatogram data and/or may allow existing analysts to redistribute their efforts to tasks other than manual quality control review. It may reduce the amount of time and costs attributed to shipping delays caused by errors and Out of Specification (OOS) investigations. When investigations or errors occur, tracing the history of anomalies in historical data may expedite root-cause analysis and even prevent future OOS generation entirely.

Still further, the described embodiments can result in improvements to analytical chemistry systems themselves. Such systems tend to generate tremendous amounts of analysis data that is often transmitted to and analyzed in networked cloud computing devices. By improving the speed of quality control processes, less data needs to be stored (and for shorter periods of time). Thus, the storage requirements of the analytical chemistry system are reduced. Less data may also need to be transmitted to the cloud for further analysis, thus improving network bandwidth and consuming fewer local-and/or cloud-based processing resources.

According to other embodiments, the method may involve machine learning and/or an unsupervised model. For example, such a method may comprise, as in the embodiment described above, accessing a plurality of samples from a chromatographic analysis, each sample represented as a structure comprising detection times and signal intensities corresponding to the detection times.

A model may be applied to each of the plurality of samples to determine a similarity score for each of the samples. The model may be, for example, a machine learning model. Such a model might apply, for example, a local outlier factor (LOF) algorithm. The LOF algorithm is a robust unsupervised method used for identifying outliers in data. It operates on the principle of detecting anomalies by measuring the local deviation of density of a given data point with respect to its neighbors. The core concept of LOF is to assess how isolated a point is in relation to its surrounding neighborhood. The algorithm begins by calculating the k-distance, which is the distance of a point to its k-th nearest neighbor. This distance helps in determining the reachability distance, defined as the maximum of the k-distance and the actual distance between two points. Subsequently, the Local Reachability Density (LRD) is computed, which is an inverse measure of the reachability distances of the k-nearest neighbors, reflecting the density around a point. The LOF score itself is then derived as the ratio of the average LRD of the neighbors to the LRD of the point in question. A score approximately equal to 1 indicates that the point has a similar density to its neighbors, while a score significantly higher than 1 flags the point as an outlier, suggesting it is in a less dense region compared to its neighbors.

This technique is particularly advantageous in datasets where the notion of an ‘outlier’ is not globally applicable but rather context-specific. The LOF algorithm excels in scenarios where the data contains clusters of varying densities, allowing it to adaptively identify outliers relative to the local densities of regions within the dataset.

Identifiers for the plurality of samples may be displayed on a display of a computing device along with a corresponding similarity score for each of the samples. As discussed above, the comparison samples may be visually distinguished based on each comparison sample's similarity score.

A selection of two or more of the comparison samples may be received. This may be, for example, to allow for a comparison between a sample that has been identified as “good” (i.e., having a similarity score above a predetermined threshold value) and a sample that has been identified as questionable (i.e., below the predetermined threshold value). A chromatogram representation of the good sample (above the predetermined threshold value of the similarity score) and a chromatogram representation of the questionable sample may be displayed.

As in the previously discussed embodiment, a pattern in a chromatogram of one of the selected comparison samples may be identified, and a processor may search through historical sample data to identify previous samples having the identified pattern.

As in the previously discussed embodiment, applying the model may reduce the number of comparison samples for individual verification, thereby increasing throughput of chromatogram review in a quality control process. The current embodiment employing unsupervised learning has the additional advantage that a user need not flag initial known-good samples; the system applies (e.g.) the LOF algorithm to determine which samples have high scores and which have low scores without the need to reference training data. This can result in further time, cost, and processing savings, and furthermore can yield objective results.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an exemplary analytical chemistry system suitable for use with one embodiment.

FIG. 2A illustrates a first exemplary data processing ecosystem in accordance with one embodiment.

FIG. 2B illustrates a second exemplary data processing ecosystem in accordance with another embodiment.

FIG. 3 depicts an exemplary interface for selecting known-good chromatography results in accordance with one embodiment.

FIG. 4 depicts an exemplary interface for displaying a match score and outlier chromatography data in accordance with one embodiment.

FIG. 5 depicts another exemplary interface for selecting known-good chromatography results in accordance with one embodiment.

FIG. 6 depicts another exemplary interface for displaying a match score and outlier chromatography data in accordance with one embodiment.

FIG. 7 depicts an exemplary interface for selecting data for training or anomaly detection in accordance with one embodiment.

FIG. 8 depicts an exemplary interface for viewing chromatography data and flagging outliers in accordance with one embodiment. accordance with one embodiment.

FIG. 9 is a flowchart depicting a technique for identifying and flagging deviations from known-good chromatography data in accordance with one embodiment.

FIG. 10 illustrates an exemplary artificial intelligence/machine learning (AI/ML) system suitable for use with exemplary embodiments.

FIG. 11 depicts an illustrative computer system architecture that may be used to practice exemplary embodiments described herein.

### DETAILED DESCRIPTION

Exemplary embodiments address (among others) the problem of low throughput and the need to manually review each chromatogram in a chromatographic quality control process. A model may be applied to chromatographic data, where the model allows aspects of the data to be quantified and/or qualified.

For instance, the model may be a supervised learning model that is trained on user-selected examples of known-good data (e.g., data that is within expected specifications). An averaged chromatogram may be built using the known-good data, and compared to the remaining data. A match factor or similarity score may be calculated for each of the chromatograms in the remaining data that reflects how closely those chromatograms match the known-good data. The model may consider, among other things, the number of peaks in the known-good data as compared to other data sets subjected to review, the shapes of the peaks, the relative positions of the peaks, and other features of the data. When the data for comparison closely matches the known-good data, it is assigned a high similarity score. When the data for comparison does not closely match the known-good data, it is assigned a low similarity score.

A threshold value may be defined (e.g., in the range of 50%-90%, preferably in the range of 65%-85%, although the specific value may depend on the particular application and/or production line) that defines an acceptable amount of deviation. In a display, the different data sets may be summarized, and may be visually distinguished based on their similarity scores.

Thus, a user (who may be an experienced analyst) can train the algorithm to recognize good data. Good results can be achieved by identifying as few as 3-5 known-good data sets. The model can be trained to recognize very specific types of data (e.g., a chromatogram representing a specific chemical compound) or may be trained more generally to recognize overall high-quality data. Deviations from the known-good data can be highlighted so that the user can quickly decide which chromatograms require further investigation and which can be dispensed after a quick review.

In some embodiments, the set of known-goods may be revised throughout the process, so that new known-good data can be incorporated into the model, or so that data previously identified as known-good can be retired as better data becomes available. The model may be retrained using the updated selections.

The model may also or alternatively be a machine learning model, which may be an unsupervised machine learning model. For example, the machine learning model may apply the Local Outlier Factor (LOF) algorithm to determine which chromatograms represent outliers. For example, the chromatograms may be grouped based on their similarity to each other, and those that are not close approximations of each other may be flagged as outliers. These embodiments have the additional advantage that no training data may be needed.

### Technical Effects and Advantages

Applying the model may have a number of technical effects/advantages. It may reduce the number of comparison samples that need to be individually verified (e.g., by allowing a user to skip or only briefly review the chromatograms with high similarity scores and/or by flagging the chromatograms with low similarity scores). Consequently, throughput of chromatogram review in a quality control process is increased. It may reduce the number of analysts needed to manually review chromatogram data and/or may allow existing analysts to redistribute their efforts to tasks other than manual quality control review. It may reduce the amount of time and costs attributed to shipping delays caused by errors and Out of Specification (OOS) investigations. When investigations or errors occur, tracing the history of anomalies in historical data may expedite root-cause analysis and even prevent future OOS generation entirely. Therefore, exemplary embodiments provide technical solutions (by applying computer-based models) to technical problems (low throughput in chromatographic quality control processes) in a particular field (chromatography). They may also be applied by particular types of machines (analysis devices communicatively coupled to, and configured to receive and interpret uniquely formatted data from, chromatography devices).

Exemplary embodiments can also solve a particular problem having to do with bad actors in chromatography-based quality control. In some cases, unscrupulous reviewers may attempt to manipulate data in order to portray a marginal or poor batch of a product as falling within acceptable specifications. This may involve, for example, manipulating the start and/or stop times of individual peaks in the data, or of the data as a whole. This can be very difficult to identify in a manual review of the data. However, because the model can identify malformed peaks or peaks that do not correspond precisely to expected values, it is much more difficult to “trick” a computer-based modeling approach, which may still flag the data as anomalous. Thus, when the data is reviewed by a second reviewer, it may become apparent that the data was manipulated.

Still further, the described embodiments can result in improvements to analytical chemistry systems themselves. Such systems tend to generate tremendous amounts of analysis data that is often transmitted to and analyzed in networked cloud computing devices. By improving the speed of quality control processes, less data needs to be stored (and for shorter periods of time). Thus, the storage requirements of the analytical chemistry system are reduced. Less data may also need to be transmitted to the cloud for further analysis, thus improving network bandwidth and consuming fewer local-and/or cloud-based processing resources. Therefore, exemplary embodiments provide improvements to computer functionality.

Embodiments employing unsupervised learning have the additional advantage that a user need not flag initial known-good samples; the system applies (e.g.) the LOF algorithm to determine which samples have high scores and which have low scores without the need to reference training data. This can result in further time, cost, and processing savings, and furthermore can yield objective results.

### A Note on Data Privacy

Some embodiments described herein make use of training data or metrics that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

Assuming a user's privacy conditions are met, exemplary embodiments may be deployed in a wide variety of messaging systems, including messaging in a social network or on a mobile device (e.g., through a messaging client application or via short message service), among other possibilities. An overview of exemplary logic and processes for engaging in synchronous video conversation in a messaging system is next provided.

### Exemplary Embodiments

As an aid to understanding, a series of examples will first be presented before detailed descriptions of the underlying implementations are described. It is noted that these examples are intended to be illustrative only and that the present invention is not limited to the embodiments shown.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

These and other features will be described in more detail below with reference to the accompanying figures.

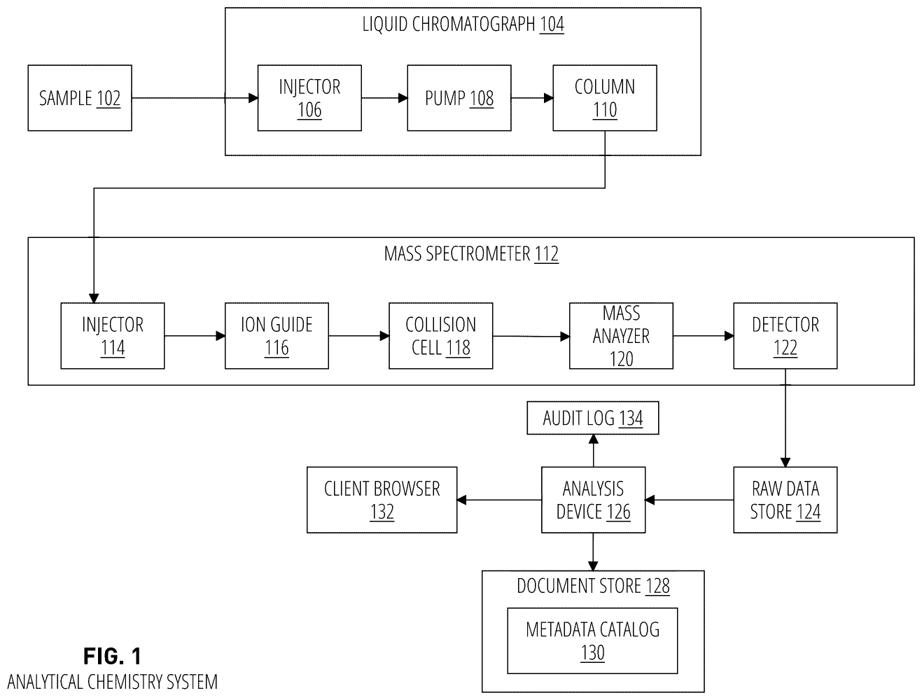

For purposes of illustration, FIG. 1 is a schematic diagram of an analytic analytical chemistry system that may be used in connection with techniques herein. Although FIG. 1 depicts particular types of devices in a specific liquid chromatography/mass spectrometry (LCMS) configuration, one of ordinary skill in the art will understand that different types of chromatographic devices (e.g., MS, tandem MS, etc.) may also be used in connection with the present disclosure.

A sample 102 is injected into a liquid chromatograph 104 through an injector 106. A pump 108 pumps the sample through a column 110 to separate the mixture into component parts according to retention time through the column.

The output from the column is input to a mass spectrometer 112 for analysis. Initially, the sample is desolved and ionized by a desolvation/ionization device 114. Desolvation can be any technique for desolvation, including, for example, a heater, a gas, a heater in combination with a gas or other desolvation technique. Ionization can be by any ionization techniques, including for example, electrospray ionization (ESI), atmospheric pressure chemical ionization (APCI), matrix assisted laser desorption (MALDI) or other ionization technique. Ions resulting from the ionization are fed to a collision cell 118 by a voltage gradient being applied to an ion guide 116. Collision cell 118 can be used to pass the ions (low-energy) or to fragment the ions (high-energy).

Different techniques may be used in which an alternating voltage can be applied across the collision cell 118 to cause fragmentation. Spectra are collected for the precursors at low-energy (no collisions) and fragments at high-energy (results of collisions).

The output of collision cell 118 is input to a mass analyzer 120. Mass analyzer 120 can be any mass analyzer, including quadrupole, time-of-flight (TOF), ion trap, magnetic sector mass analyzers as well as combinations thereof. A detector 122 detects ions emanating from mass analyzer 122. Detector 122 can be integral with mass analyzer 120. For example, in the case of a TOF mass analyzer, detector 122 can be a microchannel plate detector that counts intensity of ions, i.e., counts numbers of ions impinging it.

A raw data store 124 may provide permanent storage for storing the ion counts for analysis. For example, raw data store 124 can be an internal or external computer data storage device such as a disk, flash-based storage, and the like. An analysis 126 analyzes the stored data. Data can also be analyzed in real time without requiring storage in a storage medium 124. In real time analysis, detector 122 passes data to be analyzed directly to analysis 126 without first storing it to permanent storage.

Collision cell 118 performs fragmentation of the precursor ions. Fragmentation can be used to determine the primary sequence of a peptide and subsequently lead to the identity of the originating protein. Collision cell 118 includes a gas such as helium, argon, nitrogen, air, or methane. When a charged precursor interacts with gas atoms, the resulting collisions can fragment the precursor by breaking it up into resulting fragment ions. Such fragmentation can be accomplished by switching the voltage in a collision cell between a low voltage state (e.g., low energy, <5 V) and a high voltage state (e.g., high or elevated energy, >15V). High and low voltage may be referred to as high and low energy, since a high or low voltage respectively is used to impart kinetic energy to an ion.

Various protocols can be used to determine when and how to switch the voltage for such an MS/MS acquisition. After data acquisition, the resulting spectra can be extracted from the raw data store 124 and displayed and processed by post-acquisition algorithms in the analysis 126.

Metadata describing various parameters related to data acquisition may be generated alongside the raw data. This information may include a configuration of the liquid chromatograph 104 or mass spectrometer 112 (or other chromatography apparatus that acquires the data), which may define a data type. An identifier (e.g., a key) for a codec that is configured to decode the data may also be stored as part of the metadata and/or with the raw data. The metadata may be stored in a metadata catalog 130 in a document store 128.

The analysis 126 may operate according to a workflow, which describes a scientific method, process, or algorithm used to analyze the data. The workflow may describe how to parameterize hardware, normalize outputs, process data, etc. The analysis 126 may provide visualizations of data to an analyst at each of the workflow steps and allowing the analyst to generate output data by performing processing specific to the workflow step. The workflow may be generated and retrieved via a client browser 132. As the analysis 126 performs the steps of the workflow, it may read read raw data from a stream of data located in the raw data store 124. As the analysis 126 performs the steps of the workflow, it may generate processed data that is stored in a metadata catalog 130 in a document store 128; alternatively or in addition, the processed data may be stored in a different location specified by a user of the analysis 126. It may also generate audit records that may be stored in an audit log 134.

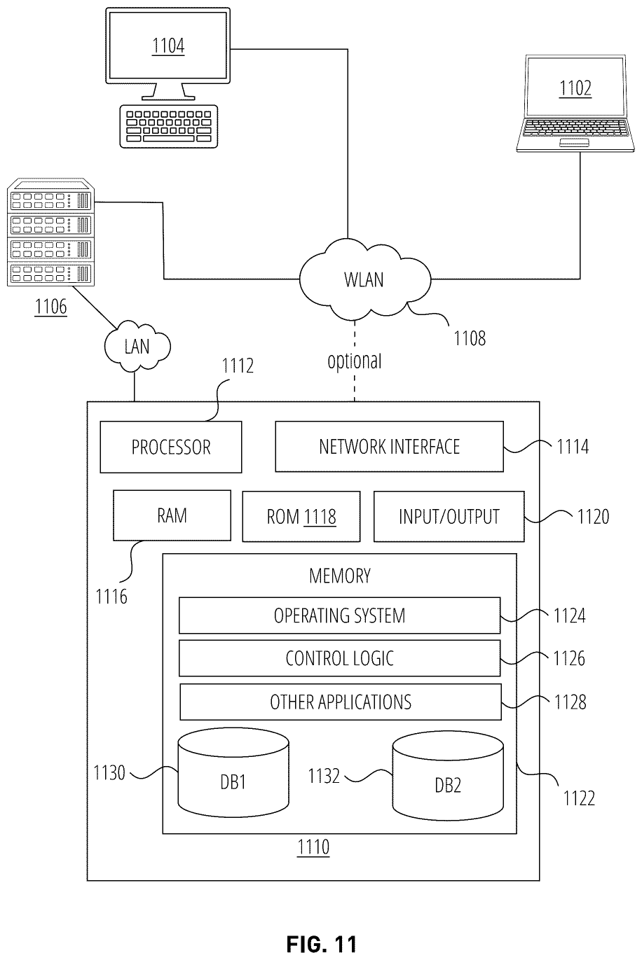

The exemplary embodiments described herein may be performed at the client browser 132 and analysis 126, among other locations. An example of a device suitable for use as an analysis 126 and/or client browser 132, as well as various data storage devices, is depicted in FIG. 11.

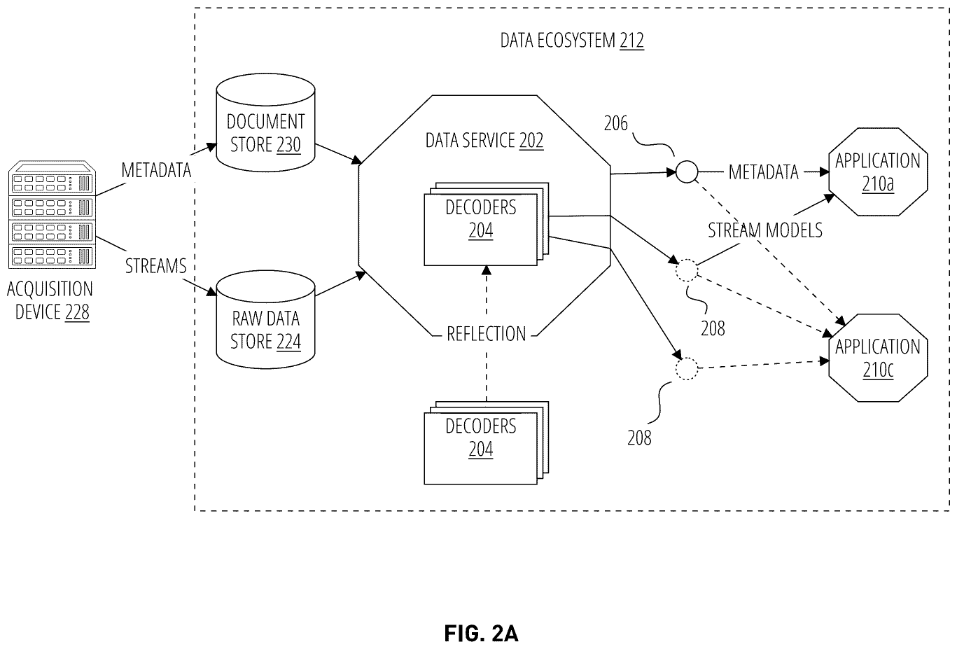

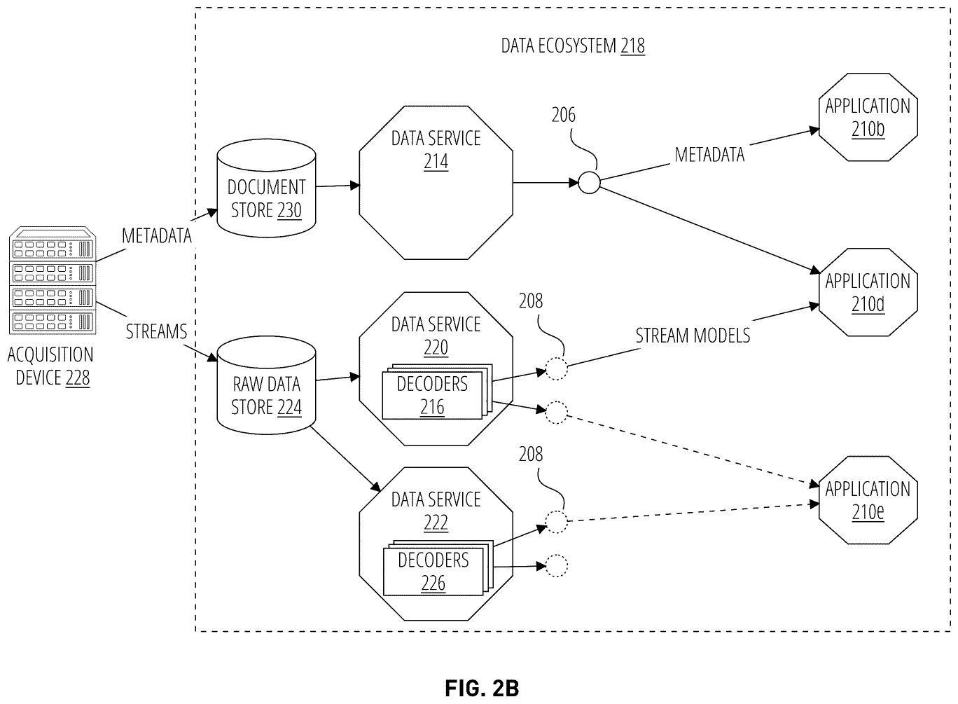

FIG. 2A depicts an exemplary data ecosystem 212 for storing and retrieving chromatography data.

A chromatography acquisition 228, such as a spectrometer, chromatography, or other device, may perform and output measurements (e.g., as a stream of readings formatted according to a data type that is specific to the acquisition 228 and/or settings applied to the acquisition 228). Those measurements may be stored in a raw data store 224.

In one example, the acquisition 228 may acquire samples using an acquisition controller service. The acquisition controller service may submit the samples, via a RESTful API call, to an acquired data receiver autonomous service. The acquired data receiver autonomous service may create a sample set, which represents the multiple samples sent for analysis into an instrument. In other words, a sample set is an organized sequence of several injections that were sent into the chromatography apparatus.

The raw data raw data store 224 may include data from multiple different chromatography apparatuses and/or chromatography apparatuses operating in multiple different acquisition modes. Accordingly, the data processing environment acts as a single source of data for applications, regardless of which device generated the data (or which mode the data was operating in). Any application calling into the ecosystem can be sure that any acquired data can be accessed and processed appropriately.

The sample set may be stored in a sample set model store, while injection raw data blobs may be sent to a separate acquired data raw blob store.

The acquisition 228 may also generate metadata describing the configuration of the acquisition 228, details of the experiment being performed, a decoder configured to decode data generated for the experiment, etc. This metadata may be stored in a metadata catalog 130. As with the raw data store 224, the metadata catalog 130 may store metadata associated with multiple different acquisition devices in multiple different configurations.

The raw data may be decodable by a set of decoders 204, where each decoder is associated with a particular data type. For example, the decoder may be associated with a particular type of raw data generated by a chromatography instrument in a specific acquisition mode. That instrument may output a stream of raw data, including (e.g.) binary data, arrays of information, etc. The decoder may be programmed to parse a stream of raw data generated by such an instrument so that the data stream can be meaningfully interpreted.

In some embodiments, a single decoder may be associated with multiple data types; in further embodiments, multiple versions of the same decoder may each be associated with different data types. The decoders 204 may be embedded within a data service 202, such as an autonomous service (e.g., via reflection).

Each of the autonomous services may expose one or more endpoint interfaces. A particular decoder may be associated with each endpoint interface. The decoder may be configured to interpret the raw data that is associated with the endpoint interface.

For example, these endpoints may Representation State Transfer (REST) endpoints capable of receiving RESTful Application Programming Interface (API) calls. An endpoint interface may receive a request for raw data acquired by a chromatography instrument. The data ecosystem 218 may expose multiple endpoint interfaces; for example, each autonomous service may be associated with and may expose at least one endpoint interface. An application 210a, 310c configured to process the raw data may call into the endpoint interface using an API call in order to retrieve the data.

The autonomous service (or another construct) may retrieve the requested raw data from a raw data store, apply the decoder to the raw data to generate decoded data, and may return the decoded data in response to the original request. For example, the autonomous service may apply the decoder to the raw data and provide decoded data to the requesting application, or the autonomous service may identify the decoder and provide it (or a location at which it can be accessed) to the requesting application along with the raw data (or a location of the raw data). In the latter case, the application may decode the data with the decoder.

Returning to the above described example, the autonomous service may retrieve the sample set models from the sample set model store and/or may retrieve the raw data blobs from the raw data blob store. The data may be decoded according to the decoder, and either version of the data (the raw data blobs or the sample set) may be provided to the application. The reason for supplying either or both of the raw data blobs and the sample set models is that the application may be tuned, for performance reasons, to use one or the other representation of the data.

By exposing the endpoint interfaces in this way, an application 210a, 310c can request data acquired by a chromatography instrument without needing to understand how to interpret the data. Furthermore, an application 210a, 310c may deposit the data in a known or common format into a central repository along with metadata indicating, e.g., when the data was received by the application, when the data was processed by the decoder, the identity of user who captured the data, the identity of the instrument that generated the data, and other information describing how and when the data was acquired. Accordingly, when new types of instruments are brought online (potentially outputting data in a different streaming format), it is not necessary to reprogram each application 210a, 310c that might use that data. Because each application 210a, 310c need not be programmed with specifics of how to interpret each different type of data stream, more different types of data can be made available to the applications, which allows for more complex analyses. This configuration also allows multiple different types of data to be stored together in a common source structure, simplifying data retrieval and storage.

In the depicted embodiment, the endpoint interfaces are of two types. A first type serves as a catalog endpoint 206, which is configured to receive requests for metadata. In response to receiving a request for metadata on the catalog endpoint 206, the data service 202 may identify the corresponding metadata in the metadata catalog 130. The data service 202 may then either return the requested metadata to the requesting application, or may return the location of the metadata so that it can be retrieved by the application as needed.

Another type of endpoint interface may serve as a data endpoint 208. There are generally a number of data endpoints 208 in the data ecosystem 212 corresponding to a number of data types that the raw data store 224 is capable of supporting. Each data endpoint 208 is characterized by a data type. When an application requests data, it may call into the raw data store or the metadata catalog to identify the type of the data; for example, the data may be tagged with a codec key that is stored with the data and/or in the metadata. The endpoint interfaces may be callable based on the data type, so once the data type is known the requesting application may identify the appropriate endpoint interface to decode the data and may formulate an appropriate RESTful API call to communicate with the interface. This provides an efficient way for the application to identify and call into the autonomous service that is capable of decoding the data.

Consequently, incoming requests are separated into metadata-specific requests and data-specific requests. Each is handled by a different type of endpoint. This helps to segregate incoming requests and provides requesting applications with a known endpoint to target for appropriate types of requests.

In this example, a single autonomous service handles requests for metadata and each different data type. Although straightforward to implement, it may be necessary to update the entire autonomous service every time one of the data types is changed, or a new data type is added. This can cause unnecessary downtime. Furthermore, the autonomous service needs to be capable of accessing both the metadata catalog 130 and the raw data store 224. These issues can be alleviated by dividing responsibility for different tasks between different autonomous services. An example of such an environment is described next in connection with FIG. 2B.

FIG. 2B illustrates an alternative configuration in which (1) metadata requests are all directed to a particular data service 214, which interfaces with the document store 230 but not the raw data store 224, and (2) data requests are submitted to any of a number of additional autonomous services, each of which has a particular decoder or set of decoders embedded and handles requests specific to the data type of its embedded decoders.

In this configuration, multiple data services 220, 322, etc. service incoming requests for data. Furthermore, at least one data service 214 is specifically configured to respond to requests for metadata. The data service 214 responding to metadata requests does not respond to requests for data, and accordingly does not need to implement any functionality related to the decoders. Similarly, the data services 220, 322, etc. responding to data requests do not need to implement any of the functionality for querying the metadata catalog. When new data types are added, a new autonomous service implementing the decoder for the new data type may be added, or an existing autonomous service may be updated with the new functionality. Meanwhile, most of the autonomous services can remain unchanged. Similarly, if the metadata catalog API is ever changed, only the metadata-handling autonomous service needs to be updated.

The raw data raw data store 224 includes data of multiple different data types. Collectively, the autonomous services may be configured to decode each of the plurality of different data types. For example, the multiple different data types may be included in an interface specification, which may describe how to decode the various different types. The interface specification may be capable of being implemented, at least in part, by each of the autonomous services by implementing corresponding data endpoints 208 and decoders 216, 324. Each data service 220, 322 may be associated with a different set of decoders 216, 324, although there may be some overlap in the decoders supported by different data services. However, no single data service implements all of the decoders, so the functionality for decoding different types of data is distributed across multiple data services. Therefore, different parts of the interface specification may be split between multiple different autonomous services, so that each implements a part, but not all, of the interface specification. Each part of the interface specification may be implemented by at least one of the autonomous services so that, collectively, the group of interface services implements the interface specification.

Because each autonomous service is tasked with only implementing a portion of the interface specification, each autonomous service can be made simpler (since it need not be concerned with providing decoders and endpoint interfaces for portions of the interface specification that it does not implement). New autonomous services can be easily added to deal with new capabilities, and it is not necessary to take down all of the autonomous services when one decoder needs to be updated.

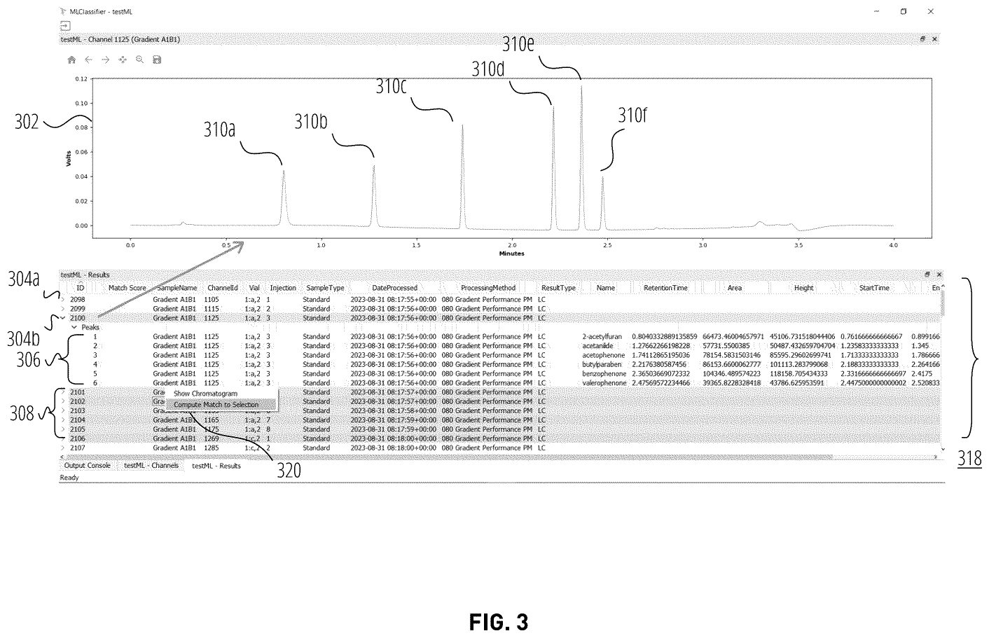

Next, FIG. 3-FIG. 8 depict exemplary interfaces suitable for modeling, scoring, and reviewing chromatography data, as discussed above. Starting at FIG. 3, an exemplary interface for selecting known-good chromatography results in accordance with one embodiment is depicted.

The interface includes a sample information display element 318 that identifies, and presents a summary of information for, data from analyzed samples in a chromatography analysis. The data may be stored in, and retrieved from, the raw data store 124. For example, the sample information display element 318 displays entries for sample data 304a.

The sample information display element 318 may allow users to select one or more data sets. In this example, the user has clicked on selected sample data 304b, as well as selected sample data 308. The selected sample data 304b was selected first, selected most recently, or was otherwise indicated as a primary set of data (e.g., by clicking a graphical element to cause the selected sample data 304b to be pinned, or by selecting the “show chromatogram” element in a context-specific dropdown menu 320 accessed by, e.g., right-clicking on the selected sample data 304b), and accordingly a chromatogram 302 of the selected sample data 304b is displayed The user has also toggled a drop-down associated with selected sample data 304b, which expands the entry for the selected sample data 304b to show peak data 306 for each of the peaks identified in selected sample data 304b. Each entry in the peak data 306 has a corresponding peak 310a, 310b, 310c, 310d, 310e, 310f depicted in the chromatogram 302. The peaks 310a-310f may optionally be labeled in the chromatogram 302. For example, in the sample shown in FIG. 3, peak 310a corresponds to 2-acetylfuran and a corresponding label may be shown above the peak 310a in the chromatogram 302.

The selections made in FIG. 3 may be identified or flagged as known-good results. For instance, by right-clicking on one of the entries for the selected sample data 304b/selected sample data 308, a context-specific dropdown menu 320 may be displayed. Selecting the “compute match to selection” element in the context-specific dropdown menu 320 may cause the selected sample data to be identified as known-good data and may cause a processor to build a model using the known-good data.

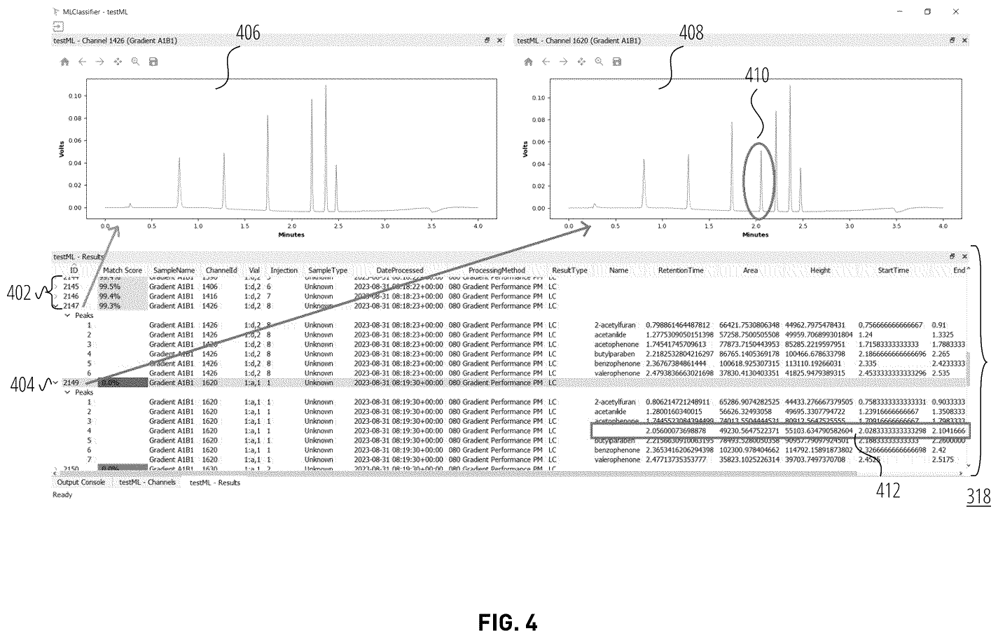

FIG. 4 depicts an exemplary interface for displaying a similarity score and outlier chromatography data in accordance with one embodiment.

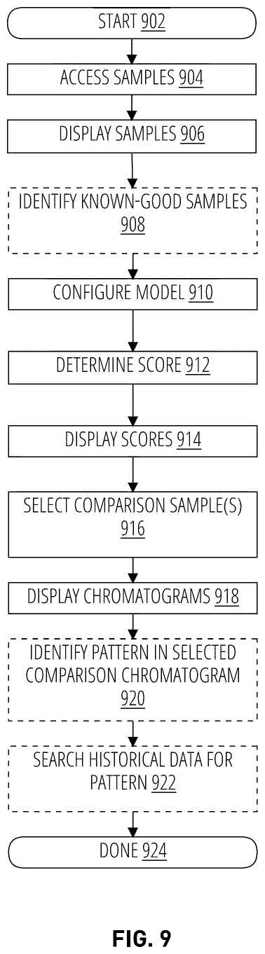

After the known-good data has been identified (or upon receiving an instruction to do so, if an unsupervised approach is employed), a similarity score may be computed for each set of chromatography data (or only for the unselected data in a comparison data set). The process for calculating a similarity score is described in more detail in connection with FIG. 9, but in general the similarity score reflects how well the comparison data matches the known-good data (or approximates ideal peak shapes, as may be the case in unsupervised learning).

The similarity score may be displayed in connection with the entries in the sample information display element 318. Relatively high match scores (e.g., above a predetermined threshold value) may be visually distinguished, such as by highlighting them in green. Such entries may be considered matched samples 402. Relatively low match scores (e.g., below the predetermined threshold value may also be visually distinguished, such as by highlighting them in red. Such entries may be considered unmatched samples 404.

A user may select an entry corresponding to a matched sample 402 and/or an unmatched sample 404. Alternatively or in addition, the system may automatically select a representative matched sample or may select the model of the known-good samples. The matched or representative sample may be displayed as a chromatogram in a matched sample display 406, while the unmatched sample may be displayed in a chromatogram in an unmatched sample display 408. This may allow for the quick comparison of samples having high and low similarity scores.

In some cases, the unmatched sample 404 may have a low similarity score, at least in part, because the unmatched sample 404 included an extra peak. The unmatched peak 410 may be quickly identified (and/or visually distinguished) in the unmatched sample display 408. An entry in the peak data for the unmatched sample may also include unmatched peak data 412. In some embodiments, the unmatched peak 410 and/or unmatched peak data 412 may not be associated with a chemical compound name, or a label on the unmatched peak 410 may be left blank (even when matched peaks in the unmatched sample display 408 include such a label).

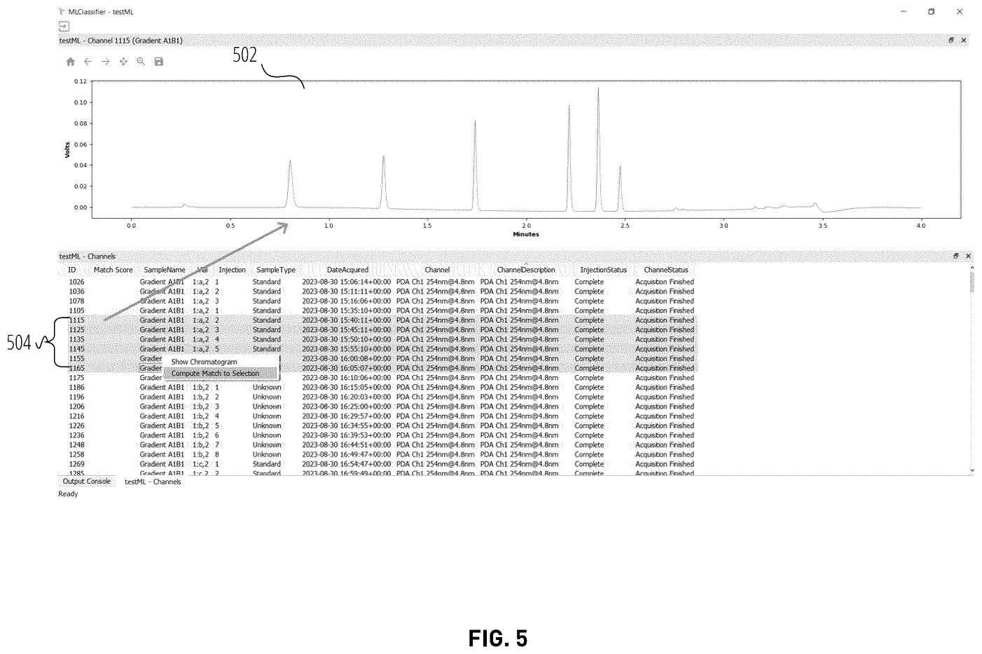

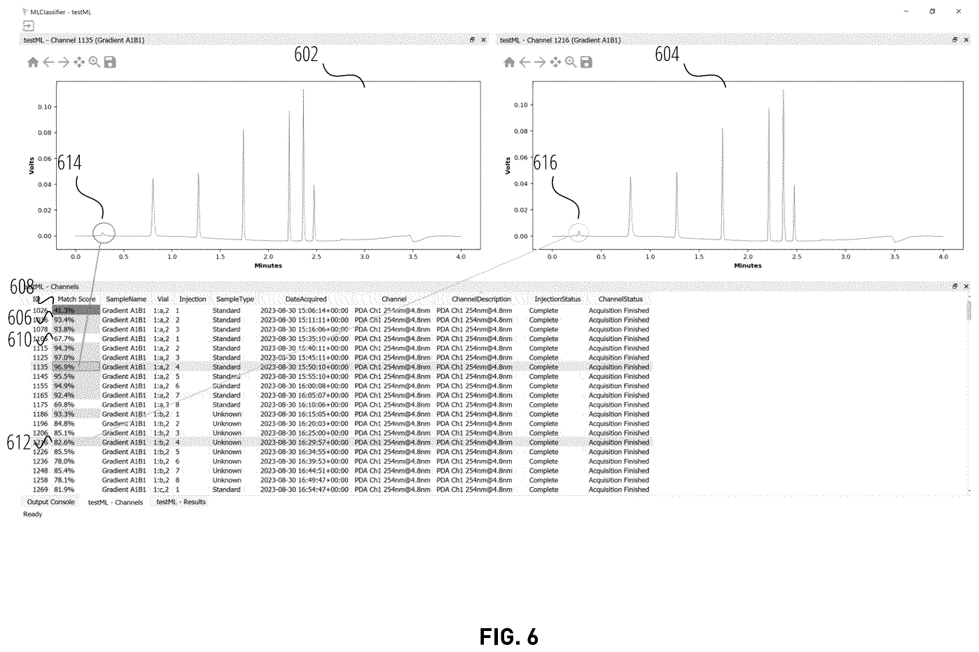

Although FIG. 4 depicts an example in which samples are either identified as being in conformity (above the predetermined threshold) and therefore matched, or out of conformity (below the predetermined threshold value), the present invention is not limited to using a single predetermined threshold value. For example, FIG. 5-FIG. 6 depict exemplary interfaces in which known-good samples are selected and broken into three groups using two threshold values.

In FIG. 5, a user can (similarly to the embodiment depicted in FIG. 3), select known-good sample data 504 and/or display chromatograms in the chromatogram display 502. After the user instructs the system to compute a match to the selected data, the interface updates as shown in FIG. 6. Similar to FIG. 4, the interface continues to provide a known-good chromatogram display 602, a chromatogram comparison display 604, matched sample data 606, and unmatched sample data 608. The matched sample data 606 may be sample data for which the similarity score was above a predetermined high threshold value (e.g., 90%) and the unmatched sample data 608 may be sample data for which the similarity score was below a predetermined low threshold value (e.g., 60%).

In between the high threshold value and the low threshold value may be data sets that are not considered to be matched or unmatched, but rather questionable sample data 610. The questionable sample data 610 may be visually distinguished from both the matched sample data 606 and the unmatched sample data 608. For example, the matched sample data 606 may be highlighted in green, the unmatched sample data 608 may be highlighted in red, and the questionable sample data 610 may be highlighted in yellow. As an alternatively, data need not be sorted in discrete buckets, as in these examples, but may rather be visually distinguished along a spectrum (e.g., a color gradient, with the specific color dependent on the similarity score).

A user may select selected questionable sample data 612 to cause a chromatogram for the selected questionable sample data 612 to be displayed in the chromatogram comparison display 604. With the questionable sample data 610, it may not be the case that extra peaks are present or some peaks are missing, but rather some peaks may be malformed or may not otherwise match up precisely with a peak in the matched sample data 606. Thus, the chromatogram comparison display 604 may include a questionable peak 616. The questionable peak 616 may be labeled with an identifier for a chemical composition that the system determines is most likely for the questionable peak 616. The questionable peak 616 may be visually distinguished from other peaks in the chromatogram comparison display 604, such as by circling it, highlighting it, or using other techniques.

Accordingly, the user can quickly compare the questionable peak 616 in the matched sample data 606 to a corresponding known-good peak 614 in the known-good chromatogram display 602 to determine if further review is necessary.

FIG. 5-FIG. 6 utilizes three categories with two predetermined threshold values, although more values may be used to break the data into more categories. The number of predetermined threshold value(s), and the values themselves, may be user configurable in some embodiments. In some embodiments, the threshold value(s) need not be predetermined, but may rather be determined dynamically (e.g., based on the characteristics of the data or the distribution of the match scores).

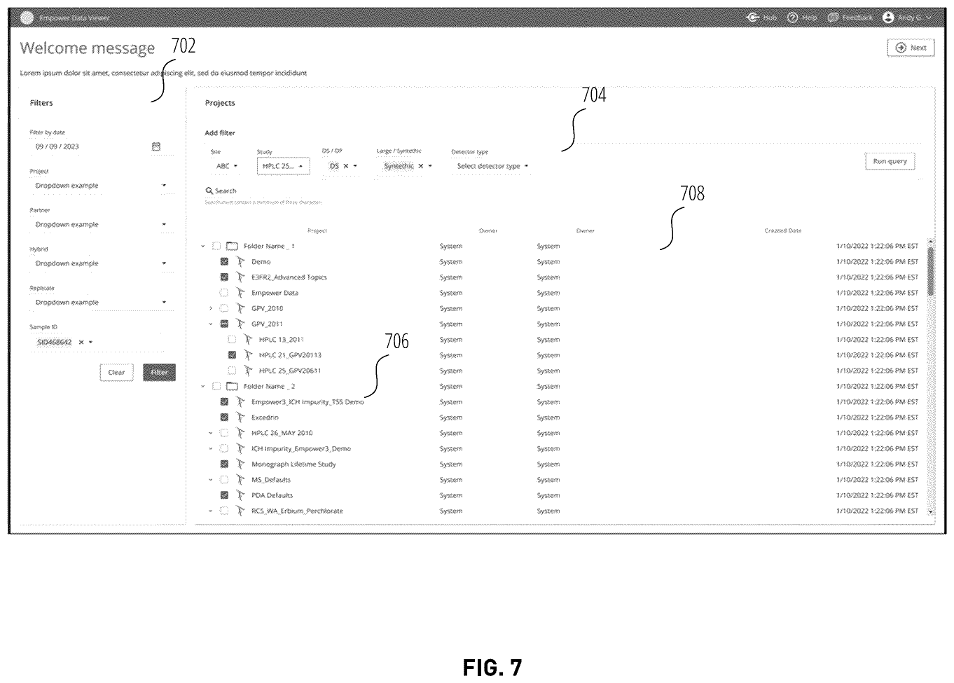

In some embodiments, data may be shared between different entities (e.g., different laboratories, different production lines, etc.). FIG. 7 depicts an exemplary interface for selecting shared data for training or anomaly detection in accordance with one embodiment. The shared data may be stored, for example, in a cloud-based environment.

The interface allows user to filter data (e.g., by user-defined tags such as site, study, sample type, instrument type, etc.). To that end, the interface includes a data filter definition interface 702 and a project filter definition interface 704 that allows the user to filter based on characteristics of the data itself and/or metadata describing parameters related to how and where the data was captured.

Data sets corresponding to the filters may be displayed in a results interface 708. The data sets may include user-captured data, third-party captured data made available to the user, and/or reference data such as known-good or ideal modeled versions of data. A user can select one or more selected data set 706 in the results interface 708 to be further analyzed.

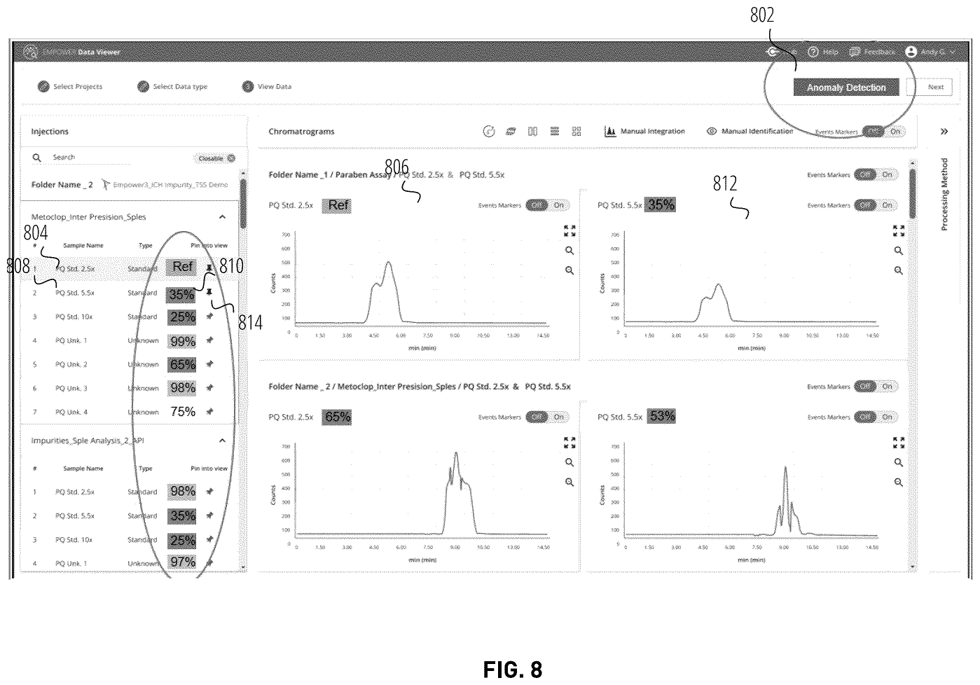

FIG. 8 depicts an exemplary interface for viewing chromatography data and flagging outliers in accordance with one embodiment. accordance with one embodiment.

This interface includes an anomaly detection mode element 802. When the anomaly detection mode element 802 is selected, a processor may perform a method such as the one described in connection with FIG. 9 to compute similarity scores nad display them in the interface. For instance, the depicted interface includes a selected reference sample 804 and a comparison sample 808 that have been selected by the user.

The user has also toggled a pin to view element 814 associated with the selected reference sample 804, causing the selected reference sample 804 to serve as the reference sample. A chromatogram for the selected reference sample 804 is displayed in a selected reference sample display 806. The user has also toggled a pin to view element 814 for the comparison sample 808, causing a chromatogram for the comparison sample 808 to be displayed in a comparison sample interface 812. The depicted interface allows up to four chromatograms to be viewed and compared simultaneously, but other embodiments may include more or fewer chromatograms.

FIG. 9 is a flowchart depicting exemplary logic for performing a computer-implemented method according to an exemplary embodiment. The logic may be embodied as instructions stored on a computer-readable medium configured to be executed by a processor. The logic may be implemented by a suitable computing system configured to perform the actions described below.

Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The method may be performed by one of more devices of an analytical chemistry system, as depicted in FIG. 1.

According to some examples, the method includes starting at start block 902. Start block 902 may commence, for example, when analysis data is generated by a chromatographic analysis and/or flagged for review (e.g., by a chromatographic quality control process on a production line; it may also be applied, for instance, in pharmaceutical research and development processes, or in chromatographic column manufacturing or research and development, among other possibilities). The analysis data may be sent to the analysis device 126 for review, which may trigger start block 902.

According to some examples, the method includes accessing samples at block 904. The samples may be stored as sample data in a sample data structure in the raw data store 124.

In the chromatographic analysis, as each compound elutes it creates a signal that rises above the baseline noise, forming what is known as a peak. The peak's height or area correlates to the compound's concentration.

Thus, each sample may be represented as a structure (e.g., a data structure) that includes detection times and signal intensities corresponding to the detection times. For example, the detection time may be a retention time (a measurement of the amount of time taken for a solute to pass through a chromatography column). The signal intensity for a given detection time may be a measurement of the number of molecules that register on a detector at the detection time. Each structure may include an identifier for the sample (e.g., a name assigned to the sample, a timestamp, etc.).

In some embodiments, peak detection may be performed to identify one or more peaks in the data for the sample, where a peak represents an area around a local maximum of the signal intensities. Sophisticated algorithms within chromatography data systems (CDS) are employed to distinguish these peaks from random noise and to accurately define their start, apex, and end. This is achieved by setting thresholds for detection parameters, such as peak width, height, and area, which may be optimized to ensure reliable peak identification. The peak width is measured at the baseline and is used to determine a bunching factor, which helps in distinguishing the peak from the baseline. The threshold parameter specifies the minimum rate of change of the detector signal required to identify the start and end of a peak. Once a potential peak start is identified, the signal is monitored until a change from a positive to a negative slope is observed, indicating the peak apex. The end of the peak is determined when consecutive slopes fall below the touchdown threshold. Minimum height or area parameters are also set to reject unwanted peaks, ensuring only significant peaks are reported. In some cases, manual integration may be used when automated methods fail to accurately capture complex peak shapes or when peaks overlap significantly.

According to some examples, the method includes displaying samples at block 906. A summary of information for the analyzed samples may be displayed on a display of a computing device. The summary of information may be displayed in a sample information display interface. Among other information, at least an identifier for each of the samples may be displayed. Examples of displaying the samples are shown in FIG. 3-FIG. 6 and FIG. 8.

The next action may depend on what type of model or learning is applied by the method. In embodiments in which supervised training is used, the method may include identifying known-good samples at block 908.

A user may select a subset of known-good samples (i.e., the subset may be a number n of samples selected from among the s analyzed sample, where 1≤n<s) from among the analyzed samples. In some embodiments, good results can be achieved with as few as 3-5 known-good samples.

The remaining samples not in the selection of the subset of known-good samples may represent a subset of comparison samples. In some embodiments, only a selected subset of the comparison samples are selected for further processing.

Examples of selecting known-good samples are shown in FIG. 3 and FIG. 5.

In embodiments employing unsupervised machine learning, block 908 may be skipped and the system may proceed directly to block 910.

According to some examples, the method includes configuring model at block 910. In embodiments employing supervised learning, the model may be configured using the subset of known-good samples. The model may be, for example, a structure or representation that abstracts properties of the known-good samples, such as the number of peaks, shapes of the peaks, etc.

In some embodiments, the model maybe a supervised learning model. For instance, the model may be an aggregated or averaged chromatogram. For example, the system may identify peaks in each of the known-good samples and may normalize the detection times from the known-good samples so that the peaks line up with each other across samples. The aligned peaks may then be averaged together (e.g., a mean intensity value at each detection time along the peak may be determined). The mean intensity values across all of the peaks may form an averaged or aggregated chromatogram. The model may be a structure that includes detection times and a mean signal intensity among the known-good samples at each detection time.

In some embodiments, rather than representing each peak point-by-point, the system may determine peak attributes for comparison. For instance, the model may include, for each identified peak, parameters such as peak retention time, area, height, start time, stop time, etc.. These parameters may be compared across different chromatograms.

According to other embodiments, the method may involve machine learning and/or an unsupervised model. For example, such a method may comprise, as in the embodiment described above, accessing a plurality of samples from a chromatographic analysis, each sample represented as a structure comprising detection times and signal intensities corresponding to the detection times.

A model may be applied to each of the plurality of samples to determine a similarity score for each of the samples. The model may be, for example, a machine learning model. Such a model might apply, for example, a local outlier factor (LOF) algorithm. The LOF algorithm is a robust unsupervised method used for identifying outliers in data. It operates on the principle of detecting anomalies by measuring the local deviation of density of a given data point with respect to its neighbors. The core concept of LOF is to assess how isolated a point is in relation to its surrounding neighborhood. The algorithm begins by calculating the k-distance, which is the distance of a point to its k-th nearest neighbor. This distance helps in determining the reachability distance, defined as the maximum of the k-distance and the actual distance between two points. Subsequently, the Local Reachability Density (LRD) is computed, which is an inverse measure of the reachability distances of the k-nearest neighbors, reflecting the density around a point. The LOF score itself is then derived as the ratio of the average LRD of the neighbors to the LRD of the point in question. A score approximately equal to 1 indicates that the point has a similar density to its neighbors, while a score significantly higher than 1 flags the point as an outlier, suggesting it is in a less dense region compared to its neighbors. This technique is particularly advantageous in datasets where the notion of an ‘outlier’ is not globally applicable but rather context-specific. The LOF algorithm excels in scenarios where the data contains clusters of varying densities, allowing it to adaptively identify outliers relative to the local densities of regions within the dataset.

According to some examples, the method includes determining similarity score at block 912. For each of the comparison samples, the model may be applied to the comparison sample to determine the similarity score. The similarity score may be a quantified or qualified representation of how closely the comparison sample matches the data from the known-good samples. For example, the similarity score may be based on a comparison of one or more of a number or shape of peaks in each comparison sample as compared to the model.

For instance, when the model is a supervised learning model with a structure representing the mean signal intensities among the known-good samples, determining the similarity score may include, for each comparison sample, determining differences between signal intensities for the comparison sample and corresponding mean signal intensities at corresponding detection times from the model, and computing the similarity score based on the differences. A greater amount of difference may result in a lower similarity score.

In some embodiments, the peak parameters may be analyzed, rather than analyzing the chromatograms/peaks point-by-point. This may be done in the supervised approach discussed above and/or the unsupervised approach discussed below. Peak parameters have been touched on above, but to provide additional detail, in the context of a chromatogram peak shape refers to the appearance of the separated components as they elute from the column. Here are the some points relating to peak shape that may be considered when computing a similarity score:
Ideal Peak Shape: An ideal peak shape is Gaussian or symmetrical. It resembles a bell curve. This shape results from a statistical treatment of solutes' transit through the chromatography system.
Tailing and Fronting: Poor peak shape can include both peak tailing (elongated tail on the right side) and peak fronting (elongated tail on the left side). These distortions affect quantitation accuracy and resolution.
Measuring Peak Shape:
   Tailing Factor (USP T_{f}): Ideally, this should be close to 1.0.
   Asymmetry: Measured at 10% of peak height.
   Efficiency: High efficiency leads to sharper peaks.
   Peak Width at Half Height: Narrower peaks improve quantitation accuracy.
Factors Affecting Peak Shape:
   Column Factors: Silica type, bonded phase, endcapping, and pore size.
   Mobile Phase Factors: Composition and pH.
   Sample Factors: Analyte properties.

The supervised learning model may also be a supervised machine learning model. In some examples, the supervised learning model may be a neural network or other machine learning construct. The supervised learning model may be trained, using the subset of known-good samples as training data. The supervised learning model may take one of the comparison samples as an input and may generate, as an output, the comparison score.

In some embodiments, the model may apply one or more heuristics or predefined penalties to improve processing speed. For example, if the number of peaks in the comparison sample do not match the number of peaks in the known-good samples, then the similarity score may be immediately set to 0. If the comparison data has too many or too few peaks, it is highly likely that the comparison data will need to be reviewed for problems such as contamination. This allows the system to quickly flag a problematic data set for further review without the need to expend processing power to calculate a more in-depth similarity score. Alternatively, the system might drop the similarity score by a predetermined amount, such as 50%.

According to some examples, the method includes displaying similarity scores at block 914. The similarity score may be displayed on the display. For example, the similarity score may be displayed near the sample identifier on the sample information display interface. In some embodiments, the different comparison sample identifiers and/or scores may be visually distinguished based on each comparison sample's similarity score. For instance, a predefined threshold are considered to be sufficiently similar to the known-good samples and scores below the threshold are considered to be anomalous. The low scores may be highlighted in red, whereas the high scores may be highlighted in green. Alternatively, other techniques for visually distinguishing the scores may be used, such as varying the size, typeface, font color, background color, font type, etc. Examples of interfaces in which the similarity score is displayed are shown in FIG. 4, FIG. 6, and FIG. 8.

According to some examples, the method includes selecting a comparison sample at block 916. Optionally, a reference sample may also be selected (for example, when the model is an unsupervised model and so no known-good examples were selected). In some embodiments, the reference sample may be selected as the sample data having the highest similarity score. The comparison sample may be displayed for comparison to the reference sample, the selected known-good sample(s), and/or the model of the known-good samples.

For instance, according to some examples, the method includes displaying chromatograms at block 918. A chromatogram representation of the known-good samples and a chromatogram representation of the selected one of the comparison samples may be displayed for comparison. In some embodiments, peaks in the chromatogram for the known-good sample may be labeled (e.g., with a molecule name corresponding to the peak). Peaks in the chromatogram for the comparison sample that correspond to the peaks in the known-good sample may also be labeled with the corresponding molecule name. Peaks in the comparison sample without an equivalent in the known-good sample may be unlabeled and/or may be visually distinguished in other ways (e.g., by highlighting, circling, bolding, etc. the unmatched peak).

According to some examples, the method includes identifying pattern in selected comparison chromatogram at block 920.

According to some examples, the method includes searching historical data for pattern at block 922. A pattern in the chromatogram of the selected comparison sample may be identified. For example, the pattern may be an unmatched peak that corresponds to an impurity, or a malformed peak that may have been caused by a miscalibration of the chromatograph or other device in an analytical chemistry system. The pattern may be a portion of chromatography data (e.g., an errant peak) or may be an entire chromatogram (e.g., corresponding to a sample having an impurity). The pattern may be automatically detected by the processor (e.g., by automatically identifying extra or missing peaks) or may be indicated by a user (e.g., by allowing the user to select a chromatogram or a portion of a chromatogram corresponding to the pattern).

A processor may conduct a search through historical sample data to identify previous samples having the identified pattern, in order to trace the source of the impurity or miscalibration. The historical sample data may be stored, for example, in the raw data store 124.

Processing may then proceed to done block 924 and terminate.

Among other advantages discussed above, applying the model may reduce the number of comparison samples for individual verification, thereby increasing throughput of chromatogram review in a quality control process.

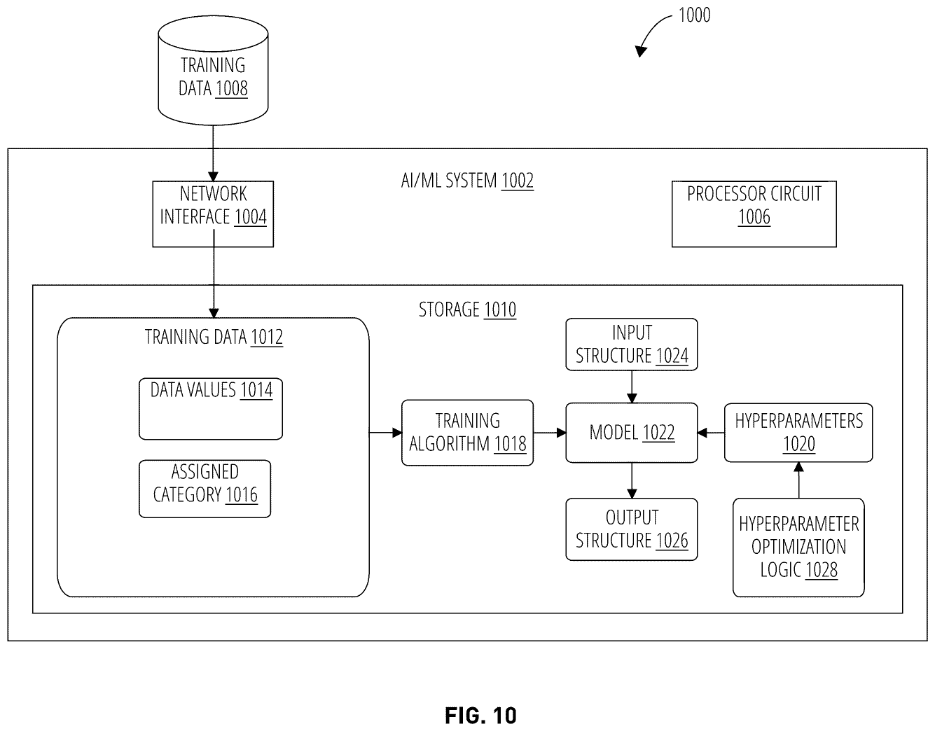

Exemplary embodiments may make use of artificial intelligence/machine learning (AI/ML). FIG. 10 depicts an AI/ML environment 1000 suitable for use with exemplary embodiments.

At the outset it is noted that FIG. 10 depicts a particular AI/ML environment 1000 and is discussed in connection with neural networks. However, other AI/ML systems also exist, and one of ordinary skill in the art will recognize that AI/ML environments other than the one depicted may be implemented using any suitable technology.

The AI/ML environment 1000 may include an AI/ML System 1002, such as a computing device that applies an AI/ML algorithm to learn relationships between the input data and a label, classification, score, or other parameters.

The AI/ML System 1002 may make use of training data 1008. In some cases, the training data 1008 may include pre-existing labeled data from databases, libraries, repositories, etc. The training data 1008 may include, for example, rows and/or columns of data values 1014. The training data 1008 may be collocated with the AI/ML System 1002 (e.g., stored in a Storage 1010 of the AI/ML System 1002), may be remote from the AI/ML System 1002 and accessed via a Network Interface 1004, or may be a combination of local and remote data. Each unit of training data 1008 may be labeled with an assigned category 1016 (or multiple assigned categories); for instance, each row and/or column may be labeled with a classification. In some embodiments, the training data may include individual data elements (e.g., not organized into rows or columns) and may be labeled on an individual basis.

As noted above, the AI/ML System 1002 may include a Storage 1010, which may include a hard drive, solid state storage, and/or random access memory.

The Training Data 1012 may be applied to train a model 1022. Depending on the particular application, different types of models 1022 may be suitable for use. For instance, in the depicted example, an artificial neural network (ANN) may be particularly well-suited to learning associations the data values 1014 and the assigned category 1016. Other types of models 1022, or non-model-based systems, may also be well-suited to the tasks described herein, depending on the designers goals, the resources available, the amount of input data available, etc.

Any suitable Training Algorithm 1018 may be used to train the model 1022. Nonetheless, the example depicted in FIG. 10 may be particularly well-suited to a supervised training algorithm. For a supervised training algorithm, the AI/ML System 1002 may apply the data values 1014 as input data, to which the resulting assigned category 1016 may be mapped to learn associations between the inputs and the labels. In this case, the assigned category 1016 may be used as a labels for the data values 1014.

The Training Algorithm 1018 may be applied using a Processor Circuit 1006, which may include suitable hardware processing resources that operate on the logic and structures in the Storage 1010. The Training Algorithm 1018 and/or the development of the trained model 1022 may be at least partially dependent on model Hyperparameters 1020; in exemplary embodiments, the model Hyperparameters 1020 may be automatically selected based on Hyperparameter Optimization logic 1028, which may include any known hyperparameter optimization techniques as appropriate to the model 1022 selected and the Training Algorithm 1018 to be used.

Optionally, the model 1022 may be re-trained over time.

In some embodiments, some of the Training Data 1012 may be used to initially train the model 1022, and some may be held back as a validation subset. The portion of the Training Data 1012 not including the validation subset may be used to train the model 1022, whereas the validation subset may be held back and used to test the trained model 1022 to verify that the model 1022 is able to generalize its predictions to new data.

Once the model 1022 is trained, it may be applied (by the Processor Circuit 1006) to new input data. The new input data may include unlabeled data stored in a data structure, potentially organized into rows and/or columns. This input to the model 1022 may be formatted according to a predefined input structure 1024 mirroring the way that the Training Data 1012 was provided to the model 1022. The model 1022 may generate an output structure 1026 which may be, for example, a prediction of an assigned category 1016 to be applied to the unlabeled input.

The above description pertains to a particular kind of AI/ML System 1002, which applies supervised learning techniques given available training data with input/result pairs. However, the present invention is not limited to use with a specific AI/ML paradigm, and other types of AI/ML techniques may be used.

FIG. 11 illustrates one example of a system architecture and data processing device that may be used to implement one or more illustrative aspects described herein in a standalone and/or networked environment. Various network nodes, such as the data server 1110, web server 1106, computer 1104, and laptop 1102 may be interconnected via a wide area network 1108 (WAN), such as the internet. Other networks may also or alternatively be used, including private intranets, corporate networks, LANs, metropolitan area networks (MANs) wireless networks, personal networks (PANs), and the like. Network 1108 is for illustration purposes and may be replaced with fewer or additional computer networks. A local area network (LAN) may have one or more of any known LAN topology and may use one or more of a variety of different protocols, such as ethernet. Devices data server 1110, web server 1106, computer 1104, laptop 1102 and other devices (not shown) may be connected to one or more of the networks via twisted pair wires, coaxial cable, fiber optics, radio waves or other communication media.

Computer software, hardware, and networks may be utilized in a variety of different system environments, including standalone, networked, remote-access (aka, remote desktop), virtualized, and/or cloud-based environments, among others.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 1110, web server 1106, and client computer 1104, laptop 1102. Data server 1110 provides overall access, control and administration of databases and control software for performing one or more illustrative aspects described herein. Data serverdata server 1110 may be connected to web server 1106 through which users interact with and obtain data as requested. Alternatively, data server 1110 may act as a web server itself and be directly connected to the internet. Data server 1110 may be connected to web server 1106 through the network 1108 (e.g., the internet), via direct or indirect connection, or via some other network. Users may interact with the data server 1110 using remote computer 1104, laptop 1102, e.g., using a web browser to connect to the data server 1110 via one or more externally exposed web sites hosted by web server 1106. Client computer 1104, laptop 1102 may be used in concert with data server 1110 to access data stored therein, or may be used for other purposes. For example, from client computer 1104, a user may access web server 1106 using an internet browser, as is known in the art, or by executing a software application that communicates with web server 1106 and/or data server 1110 over a computer network (such as the internet).

Servers and applications may be combined on the same physical machines, and retain separate virtual or logical addresses, or may reside on separate physical machines. FIG. 11 illustrates just one example of a network architecture that may be used, and those of skill in the art will appreciate that the specific network architecture and data processing devices used may vary, and are secondary to the functionality that they provide, as further described herein. For example, services provided by web server 1106 and data server 1110 may be combined on a single server.

Each component data server 1110, web server 1106, computer 1104, laptop 1102 may be any type of known computer, server, or data processing device. Data server 1110, e.g., may include a processor 1112 controlling overall operation of the data server 1110. Data server 1110 may further include RAM 1116, ROM 1118, network interface 1114, input/output interfaces 1120 (e.g., keyboard, mouse, display, printer, etc.), and memory 1122. Input/output interfaces 1120 may include a variety of interface units and drives for reading, writing, displaying, and/or printing data or files. Memory 1122 may further store operating system software 1124 for controlling overall operation of the data server 1110, control logic 1126 for instructing data server 1110 to perform aspects described herein, and other application software 1128 providing secondary, support, and/or other functionality which may or may not be used in conjunction with aspects described herein. The control logic may also be referred to herein as the data server software control logic 1126. Functionality of the data server software may refer to operations or decisions made automatically based on rules coded into the control logic, made manually by a user providing input into the system, and/or a combination of automatic processing based on user input (e.g., queries, data updates, etc.).

Memory 1122 may also store data used in performance of one or more aspects described herein, including a first database 1132 and a second database 1130. In some embodiments, the first database may include the second database (e.g., as a separate table, report, etc.). That is, the information can be stored in a single database, or separated into different logical, virtual, or physical databases, depending on system design. Web server 1106, computer 1104, laptop 1102 may have similar or different architecture as described with respect to data server 1110. Those of skill in the art will appreciate that the functionality of data server 1110 (or web server 1106, computer 1104, laptop 1102) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

Exemplary embodiments as discussed above include, but are not limited to, the following:
1. A computer-implemented method comprising: accessing a plurality of samples from a chromatographic analysis, each sample represented as a structure comprising detection times and signal intensities corresponding to the detection times; displaying identifiers for the plurality of samples on a display of a computing device; receiving a selection of a subset of known-good samples from the plurality of samples, remaining samples not in the selection of the subset of known-good samples representing a subset of comparison samples; using the subset of known-good samples to train a model; for each of the comparison samples, applying the model to the comparison sample to determine a similarity score; displaying the similarity score on the display; receiving a selection of one of the comparison samples; and displaying a chromatogram representation of the known-good samples and a chromatogram representation of the selected one of the comparison samples.
2. The computer-implemented according to (1), wherein receiving the selection comprises receiving a selection of 3-5 samples from the plurality of samples.
3. The computer-implemented method according to any of (1)-(2), further comprising visually distinguishing the comparison samples based on each comparison sample's similarity score.
4. The computer-implemented method according to any of (1)-(3), wherein the model is a supervised learning model.
5. The computer-implemented method according to (4), wherein: the model is a structure comprising detection times and a mean signal intensity among the known-good samples at the detection time; and determining the similarity score for the comparison samples comprises, for each comparison sample, determining differences between signal intensities for the comparison sample and corresponding mean signal intensities at corresponding detection times from the model, and computing the similarity score based on the differences, wherein a greater amount of difference results in a lower similarity score.
6. The computer-implemented method according to any of (1)-(5), wherein the similarity score is based on a comparison of one or more of a number or shape of peaks in each comparison sample as compared to the model.
7. The computer-implemented method according to any of (1)-(6), further comprising: identifying a pattern in a chromatogram of the selected comparison sample; and searching through historical sample data to identify previous samples having the identified pattern.
8. The computer-implemented method of according to any of (1)-(7), wherein applying the model reduces the number of comparison samples for individual verification, thereby increasing throughput of chromatogram review in a quality control process.
9. A computer-implemented method comprising: accessing a plurality of samples from a chromatographic analysis, each sample represented as a structure comprising detection times and signal intensities corresponding to the detection times; applying a model to each of the plurality of samples to determine a similarity score for each of the samples; displaying identifiers for the plurality of samples on a display of a computing device and a corresponding similarity score for each of the samples; receiving a selection of two or more of the comparison samples, at least one of the selected comparison samples having a similarity score above a predetermined threshold value and at least one of the selected comparison samples having a similarity score below the predetermined threshold value; and displaying chromatogram representations of the selected two or more comparison samples.
10. The computer-implemented method according to (9), wherein the model is a machine learning model.
11. The computer-implemented method according to (10), wherein machine learning model applies a local outlier factor algorithm.
12. The computer-implemented method according to any of (9)-(11), further comprising visually distinguishing the comparison samples based on each comparison sample's similarity score.
13. The computer-implemented method according to any of (9)-(12), further comprising: identifying a pattern in a chromatogram of the selected comparison sample; and searching through historical sample data to identify previous samples having the identified pattern.
14. The computer-implemented method according to any of (9)-(11), wherein applying the model reduces the number of comparison samples for individual verification, thereby increasing throughput of chromatogram review in a quality control process.
15. A non-transitory computer-readable storage medium storing instructions that, when executed by one or more processors, cause the one or more processors to perform the method according to any of (1)-(14).
16. An apparatus comprising: a non-transitory computer-readable storage medium storing logic for performing the method according to any of (1)-(14), and a processor configured to execute the logic.
17. An analytical chemistry system comprising: the apparatus of (16), and a chromatograph configured to perform the chromatographic analysis.

What is claimed is:

1. A computer-implemented method comprising:
accessing a plurality of samples from a chromatographic analysis, each sample represented as a structure comprising detection times and signal intensities corresponding to the detection times;
displaying identifiers for the plurality of samples on a display of a computing device;
receiving a selection of a subset of known-good samples from the plurality of samples, remaining samples not in the selection of the subset of known-good samples representing a subset of comparison samples;
using the subset of known-good samples to configure a model;
for each of the comparison samples, applying the model to the comparison sample to determine a similarity score;
displaying the similarity score on the display;
receiving a selection of one of the comparison samples; and
displaying a chromatogram representation of the known-good samples and a chromatogram representation of the selected one of the comparison samples.

2. The computer-implemented method of claim 1, wherein receiving the selection comprises receiving a selection of 3-5 samples from the plurality of samples.

3. The computer-implemented method of claim 1, further comprising visually distinguishing the comparison samples based on each comparison sample's similarity score.

4. The computer-implemented method of claim 1, wherein the model is a supervised learning model.

5. The computer-implemented method of claim 4, wherein:
the model is a structure comprising detection times and a mean signal intensity among the known-good samples at the detection time; and
determining the similarity score for the comparison samples comprises, for each comparison sample, determining differences between signal intensities for the comparison sample and corresponding mean signal intensities at corresponding detection times from the model, and computing the similarity score based on the differences, wherein a greater amount of difference results in a lower similarity score.

6. The computer-implemented method of claim 1, wherein the similarity score is based on a comparison of one or more of a number or shape of peaks in each comparison sample as compared to the model.

7. The computer-implemented method of claim 1, further comprising:
identifying a pattern in a chromatogram of the selected comparison sample; and
searching through historical sample data to identify previous samples having the identified pattern.

8. The computer-implemented method of claim 1, wherein applying the model reduces the number of comparison samples for individual verification, thereby increasing throughput of chromatogram review in a quality control process.

9. A computer-implemented method comprising:
accessing a plurality of samples from a chromatographic analysis, each sample represented as a structure comprising detection times and signal intensities corresponding to the detection times;
applying a model to each of the plurality of samples to determine a similarity score for each of the samples;
displaying identifiers for the plurality of samples on a display of a computing device and a corresponding similarity score for each of the samples;
receiving a selection of two or more of the comparison samples, at least one of the selected comparison samples having a similarity score above a predetermined threshold value and at least one of the selected comparison samples having a similarity score below the predetermined threshold value; and
displaying chromatogram representations of the selected two or more of the comparison samples.

10. The computer-implemented method of claim 9, wherein the model is a machine learning model.

11. The computer-implemented method of claim 10, wherein machine learning model applies a local outlier factor algorithm.

12. The computer-implemented method of claim 10, further comprising visually distinguishing the comparison samples based on each comparison sample's similarity score.

13. The computer-implemented method of claim 10, further comprising:
identifying a pattern in a chromatogram of the selected comparison sample; and
searching through historical sample data to identify previous samples having the identified pattern.

14. The computer-implemented method of claim 10, wherein applying the model reduces the number of comparison samples for individual verification, thereby increasing throughput of chromatogram review in a quality control process.

15. A non-transitory computer-readable storage medium storing instructions that, when executed by one or more processors, cause the one or more processors to:
access a plurality of samples from a chromatographic analysis, each sample represented as a structure comprising detection times and signal intensities corresponding to the detection times;
display identifiers for the plurality of samples on a display of a computing device;
receive a selection of a subset of known-good samples from the plurality of samples, remaining samples not in the selection of the subset of known-good samples representing a subset of comparison samples;
use the subset of known-good samples to configure a model;
for each of the comparison samples, apply the model to the comparison sample to determine a similarity score;
display the similarity score on the display;
receive a selection of one of the comparison samples; and
display a chromatogram representation of the known-good samples and a chromatogram representation of the selected one of the comparison samples.

16. An apparatus comprising:
one or more processors configured to perform a method for displaying chromatogram representations, and
a non-transitory computer-readable storage medium storing instructions that, when executed by the one or more processors, cause the one or more processors to:
access a plurality of samples from a chromatographic analysis, each sample represented as a structure comprising detection times and signal intensities corresponding to the detection times;
display identifiers for the plurality of samples on a display of a computing device;
receive a selection of a subset of known-good samples from the plurality of samples, remaining samples not in the selection of the subset of known-good samples representing a subset of comparison samples;
use the subset of known-good samples to configure a model;
for each of the comparison samples, apply the model to the comparison sample to determine a similarity score;
display the similarity score on the display;
receive a selection of one of the comparison samples; and
display a chromatogram representation of the known-good samples and a chromatogram representation of the selected one of the comparison samples.

17. An analytical chemistry system comprising: the apparatus of claim 16, and a chromatograph configured to perform the chromatographic analysis.
